(19) United States
(12) Patent Application Publication
(10) Pub. No.: US 2015/0262497 A1
(43) Pub. Date: Sep. 17, 2015

(54) CUSTOMIZED WELLNESS PLANS USING ACTIVITY TRACKERS

(71) Applicant: FITBUG LTD., London (GB)

(72) Inventors: Paul Landau, London (GB); Danny Ogen, London (GB)

(21) Appl. No.: 14/659,539

(22) Filed: Mar. 16, 2015

Related U.S. Application Data
(60) Provisional application No. 61/953,542, filed on Mar. 14, 2014.

(51) Int. Cl. G09B 5/06; G09B 5/00; G09B 19/00; G06F 19/00

(52) U.S. Cl. CPC G09B 5/06; G06F 19/3406; G09B 5/00; G09B 19/003; G09B 19/0092; G09B 19/00

(57) ABSTRACT

Exemplary embodiments of methods and systems are provided for customized wellness plans to users based on activity detected by an activity tracking devices. In some embodiments, a method of providing a wellness plan is provided, comprising offering one or more wellness plans to a user, allowing the user to enter input parameters personal to the user, synching an activity tracking device with information associated with the user for use with a chosen wellness plan, configuring a customized wellness plan for the user based on an algorithm and the input parameters, and providing the customized wellness plan to the user.

### CROSS-REFERENCE TO RELATED APPLICATION(S)

This application relates to and claims priority from U.S. Patent Application Ser. No. 61/953,542 filed Mar. 14, 2014, the entire disclosure of which is hereby incorporated by reference.

### FIELD OF THE DISCLOSURE

The present disclosure relates to exemplary embodiments of systems and methods for providing customized wellness plans, and more particularly, to exemplary embodiments of systems and methods for providing customized wellness plans using activity trackers.

### BACKGROUND INFORMATION

Various activity tracking devices are provided in which rewards or other types of benefits are provided based on usage of the activity trackers. However, using the activity tracking devices for e.g., targeted wellness programs in a personalized coaching plan, are not provided. Therefore, there is a need for systems and methods for providing customized wellness plans using activity trackers.

### SUMMARY OF EXEMPLARY EMBODIMENTS OF THE DISCLOSURE

At least some of the above described problems can be addressed by exemplary embodiments of the methods and systems according to the present disclosure, which can provide wellness plans, systems and methods of subscription to the wellness plans, and systems and methods of implementation of the wellness plan.

In some exemplary embodiments, wellness plans can be programs designed to train, coach, and educate users to achieve, manage, and maintain a defined set of fitness, lifestyle, and wellness goals, conditions, habits, or situations (“wellness objectives”). The exemplary wellness plans can be tailored to distinct wellness objectives including but not limited to fitness level, targeted body member, chronic medical situation, rehabilitation, activity, lifestyle, and life event(s). The wellness plans can be personalized to a user's unique medical condition, wellness, fitness, lifestyle, and objective(s).

In some exemplary embodiments, the wellness plans can make use of data provided by activity and lifestyle trackers, medical diagnostics, and user reported metrics and information. The wellness plans can be customized to the metrics measured, recorded, or reported by tracker devices and reported or input by the user. The wellness plans are not limited to any particular device or activity and lifestyle tracker type or brand, and can be used with any tracker or device that can measure, record or report the activity and lifestyle metrics needed to implement the plan. The metrics for implementing the plan can be unique to an individual plan.

In some exemplary embodiments, the wellness plans can be for a fixed term of undertaking. The term being chosen can be based on optimum time needed to instill new wellness habits which can be determined by behavioral psychology, or meet particular rehabilitation, training, or conditioning needs. In some exemplary embodiments, the wellness plans can make use of a large set of user input parameters to customize the wellness plan to the user's individual health, wellness, and lifestyle conditions. In some exemplary embodiments, the wellness plans can require a subscription to an individual plan. The subscriptions can be initiated by purchasing a subscription code/identifier.

In some exemplary embodiments, the wellness plan can provide individualized training, coaching, and education including videos, animations, audios, articles, recipes, blogs, community forums, motivational messages, or text or SMS messages. The training, coaching, and education vehicles can be pushed to the user.

In some exemplary embodiments, the wellness plan can integrate a structured wellness program combined with a set of user parameter inputs, responses from activity and lifestyle trackers, health devices, and user-self reports to customize a wellness program unique to an individual user. The wellness plans can be designed based on a user's unique personal characteristics and lifestyle condition(s).

In some exemplary embodiments, the wellness plan can be continuously customized by the user's wellness achievements and conditions. The wellness plans can be tailored so as to target or achieve a defined objective, and can be implemented over a fixed duration of time. The wellness plans can make use of psychology behavior change, wellness, sports and fitness, and can include comprehensive training, coaching, and education customized to the wellness objective of the plan and the user's health, wellness, and lifestyle conditions. The wellness plans can be activated via a subscription code, which can be sold, purchased, or otherwise acquired or obtained in the form of printed or electronic media.

In some exemplary embodiments of the present disclosure, a method of providing a wellness plan is provided, comprising offering one or more wellness plans to a user, allowing the user to enter input parameters personal to the user, synching an activity tracking device with information associated with the user for use with a chosen wellness plan, configuring a customized wellness plan for the user based on an algorithm and the input parameters, and providing the customized wellness plan to the user.

The customized wellness plan can include one or more of types of exercises, frequency of exercises, duration of exercises, number of repetitions and sets of exercises, intensity of exercises, activity and lifestyle metrics to be monitored and reported, nutritional goals, mode of communication, reporting to social media, frequency of communications, communication with health professional, goals, benchmarks, calories to be burned and exercise limitations.

The method can further comprise determining compliance with the customized wellness plan using synchronization of data from the activity tracking device. The customized wellness plan can be for a fixed duration of time. The method can further comprise using a customized algorithm to determine the user's progress based on the customized wellness plan during the fixed duration of time. The fixed duration of time can be from one to twelve weeks.

The method can further comprise offering customized motivational coaching with the customized wellness plan to the user to ensure compliance with the customized wellness plan. The customized motivation coaching can include motivational messages and tips for completing the customized wellness program. The method can further comprise providing customized training to the user based on a specific algorithm suited to the particular user. The algorithm can be based on the customized wellness plan and the input parameters. The customized training can include one or more of audio files, video files and text files.

The method can further comprise offering a reward or feedback to the user upon successful completion of the customized wellness plan. The method can further comprise offering another wellness plan after completion of the customized wellness plan based on activity by the user in the customized wellness plan.

The one or more wellness plans offered can be based on one or more wellness objectives. The wellness objectives can include one or more of fitness goals, conditioning of a targeted body member or region of the body, health situation, rehabilitation need, activity, lifestyle, life event and a life goal. The one or more wellness plans offered can be based on a subscription. The subscription can be Internet enabled or based on a subscription code. The subscription can end after a fixed duration of time.

The activity tracking device can be one of a pedometer, accelerometer, altimeter, tachometer, oxygen partial pressure (pO2) sensor, calorimeter, gyroscope, actuator, pressure sensor, speed sensor, camera, heart rate monitor, heart rate measuring device, pulse measuring device, blood pressure measuring device, temperature measurement device, temperature sensor, location tracking device, GPS, computer, brain wave sensor, sleep sensor or scale.

The method can further comprise providing information regarding the progress of the user based on the customized wellness plan in a customized software application for the user.

These and other objects, features and advantages of the present disclosure will become apparent upon reading the following detailed description of embodiments of the present disclosure, when taken in conjunction with the appended claims.

### BRIEF DESCRIPTION OF THE DRAWINGS

The foregoing and other objects of the present disclosure will be apparent upon consideration of the following detailed description, taken in conjunction with the accompanying drawings and claims, in which like reference characters refer to like parts throughout, and in which:

FIG. 1 is an illustration of a wellness plan according to an exemplary embodiment of the present disclosure; and

FIG. 2 is a block diagram of a wellness plan system according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

According to the exemplary embodiments of the present disclosure, the wellness plans can be goal oriented subscription based programs designed to coach users to achieve, manage, and maintain a defined set of health, fitness, lifestyle, and wellness goals, conditions, habits, or situations (“wellness objectives”), and can be customized to a user's unique health, wellness, fitness, and lifestyle condition. The wellness plans can be outcome based plans tailored to conditions for a user to achieve a particular objective(s). A user can select a wellness plan that can enable their individual wellness objective(s).

Some wellness objectives can include, but are not limited to, fitness goals, conditioning of a targeted body member or region of the body, health situation, rehabilitation need, activity, lifestyle, life event, and/or life goal. The objectives can include, but are not limited to, weight loss, sleep improvement, stress reduction, improving depression, mood enhancement, smoking cessation, improving wellness to manage chronic pain (e.g., back pain or joint pain), body part or body region conditioning (e.g., shoulders, back, chest, abdomen, buttocks or legs), life occasion (e.g., wedding, honeymoon, season (e g summer readiness), beach going, school reunion, family reunion or dating), pre-natal conditioning, post-natal conditioning, improving wellness following a medical condition (e.g., stroke, surgery, cardiac event or condition), improving wellness to manage chronic health conditions (e.g. diabetes or arthritis), improving wellness during rehabilitation of a body part (e.g., knee, hip, back, neck, Achilles tendon, knee ligaments, wrist, elbow or carpal tunnel syndrome), general conditioning (e.g., stretching), sport or activity specific conditioning (e.g., skiing, golf, tennis, gardening, walking, dancing, yoga, Pilates, weight lifting, football, soccer, basketball, running, swimming or bicycling), or preparation for sport or charity races, events, or challenges preparation (e.g., running challenges, half-marathons, marathons, triathlons, obstacle courses, biking, swimming or other competitive or charity races or events), etc.

The exemplary wellness plans can also be themed to reflect the objective. For example, a wellness program for post-natal conditioning may be themed “No More Baby Belly.” The wellness plans can be designed in consultation with specialists including nutritionists, physical therapists, occupational therapists, medical professionals, exercise physiologists, fitness trainers, psychologists or professional coaches.

### Activity Tracking and Health Monitoring

In some exemplary embodiments, the wellness plans can be designed to work with and can be enabled by activity and lifestyle trackers and health monitoring devices. Activity and lifestyle trackers include devices that can measure, calculate, record, sense, and transmit information and signals, including but not limited to, pedometers, accelerometers, altimeters, tachometers, oxygen partial pressure (pO2) sensors, calorimeters, gyroscopes, actuators, pressure sensors, speed sensors, cameras, heart rate monitor and measuring devices, pulse measuring devices, blood pressure measuring devices, temperature measurement devices and sensors, location tracking devices, GPS, computers, brain wave sensors, sleep sensors, scales and other weight measurement devices, or any other device which measures, monitors, and records health, wellness, and lifestyle metrics.

In some exemplary embodiments, the activity and lifecycle trackers can be devices worn or carried by the user or affixed to a machine, apparatus, or instrument used for physical training. Activity and lifestyle trackers worn by the user include devices embedded in, attached to, or comprising, in whole or in part, bracelets, wrist watches, earrings, rings, cuffs, finger sensors, chest straps, clothing, smart shirts, smart shorts, smart leggings, smart undergarments, removable sensors, smart watches, smartphones, belt or waistband clips, glasses and smart glasses, shoes, headbands, wrist bands, arm bands, fitness bands, prosthetics, textiles, and other wearable or body-borne devices and electronic textiles. Activity and lifestyle trackers include, but are not limited to, devices under the FITBUG brand name such as the FITBUG AIR, FITBUG GO, FITBUG ORB, and FITBUG WOW.

The wellness plans are not limited to any particular activity and lifestyle tracker type or brand or device type or brand, but instead can be used with any tracker or device that can measure, record, and/or report the activity and lifestyle metrics needed to implement the plan. The wellness plans are not limited to a particular computing or mobile phone device, but can be used on a host of computing or mobile phone devices.

Activity and lifestyle tracker devices can also include machines, apparatuses or instruments, or devices attached to or comprising machines, apparatuses or instruments of locomotion and mobility, such as bicycles, tricycles, unicycles, and any other velocipedes, wheel chairs, rowing machines, spinning machines, treadmills, weight or resistance machines, walkers, crutches, shoes, pads, mats, steps, etc. The activity and lifestyle trackers may be removable, affixed, embedded, attached or otherwise comprising a machine, apparatus, instrument, device or article of clothing or textile.

The activity and lifestyle tracker can transmit or receive information or signals either via a wired connection or wireless transmission to and from a computing or communication device, including but not limited to, a computer, tablet, smartphone, smart watch, smart eyewear, or other device.

Health monitoring devices can include scales, smart scales, body fat monitors and measuring devices, blood pressure measurement devices, temperature sensing devices, thermometers, pulse measuring devices, partial pressure (pO2) sensors, heart rate sensors, calipers, and other health and medical devices which provide information on the user's fitness, wellness, mood, sleep, medical state, medical condition or fitness condition.

### User Input Data

In some exemplary embodiments, the wellness plans can be customized to the user's physiological, psychological, medical, and nutritional conditions. At the initiation of a wellness plan, the user can be prompted to provide personal input parameters. These personal input parameters can include, but are not limited to, age, sex, weight, height, body measurements (e.g., waist, hips, chest, arms, or legs), blood pressure, pulse rate, smoking (amount and frequency), psychological well-being, motivational levels, confidence score, stress level, mood, depressive symptoms, exercise and fitness (including but not limited to type, duration, frequency, length of time engaged in the activity, exertion and whether performed alone or with partner(s)), user medical condition and medical history, and family medical history (including but not limited to blood pressure, temperature, heart disease, heart attack, angina, heart failure, cancer, high or low blood pressure, cholesterol level, stroke, diabetes, metabolic disorders and back pain), cholesterol level, blood pressure, sleep quantity, sleep quality, sleep duration, sleep condition, objectives (e.g., weight loss, physical conditioning, fitness, sleep or relaxation), medical professionals information (name, address, phone & fax numbers, e-mail, etc.). clearance given by a medical professional, nutritional information (including but not limited to diet, portions and frequency of fruits and vegetables, whole grains, salt, red meats, fish, food high in saturated fats, alcohol, sugar and water), allergies and other food limitations, vitamins and other nutritional supplements, medical conditions or medications which affect, or are effected by, nutrition and diet, and pregnancy information (including but not limited to due date, length of time since delivery, number of pregnancies, vaginal or cesarean childbirth, natural childbirth and miscarriages).

The user can be prompted by a series of questions to enter the input parameters above. Entries can be input or selected from those of drop down menus, check boxes, sliders, dials, or other common data input formats, or freely input by the users. This information can also be imported from external third party apps/websites. The user can periodically be prompted to update one or more of their personal input parameters. The user may also be prompted to embed, attach, or upload a photographic image of the user.

In some exemplary embodiments, the wellness plan uses the user's personal input parameters to construct a customized wellness plan consistent with the wellness plan objectives. The wellness plan is built on a wellness plan specific activity, nutrition, and lifestyle, program to achieve a given wellness objective. The program is then customized to the user by accounting for the user's input parameters and the health, wellness, and lifestyle progress the user achieves. The required user input parameters needed for a given wellness plan are chosen by the plan designer and based on the particular information needed to implement, monitor, and record the selected wellness plan.

The wellness plan can provide the user with a baseline wellness profile constructed from the user input parameters. This profile can be in the form of reports, charts, tables, and graphical presentation. The profile can be on a web page and or mobile software application (“App”). The wellness plan can also provide daily, weekly, monthly, and plan duration reports in the form of text, charts, tables, calendars, and graphical presentations.

### Duration of Wellness Plans

In some exemplary embodiments, the wellness plans can be designed to be implemented and conducted for a fixed length of time. The fixed length of time can be any designated time period, such as anywhere from 1 to 24 weeks, and specifically, 6 weeks, more specifically, 12 weeks, and even more specifically, 18 weeks.

Some psychology, sports psychology, and cognitive behavioral therapy have identified 12 weeks as the length of time needed to change existing behavior patterns and habits and imprint, implement, and assimilate a new behavior. These 12 weeks can further be grouped into distinct stages. The first stage can be an induction stage, which can be between weeks 1-4, characterized by excitement in a new activity or initiating a behavior modification through self-awareness by monitoring lifestyle parameters and changes, and providing education about what needs to change. The second stage can be a reaction stage, which can be in between weeks 5-8, which can be characterized by resistance to change in which a person finds themselves struggling with completing positive habits and it is easy to relapse into old habits, and sustaining positive behaviors and changing habits. The final stage can be a reformation stage, which can be between weeks 9-12, which can be characterized by the imprinting of the new habit.

In some exemplary embodiments, the wellness plans may be designed for shorter terms of 1 to 8 weeks, and specifically, 6 weeks. Wellness plans can also be designed for longer terms of 13 to 24 weeks, and specifically, 18 weeks. Shorter term and longer term plans may be designed to accommodate the shorter or longer periods required for rehabilitation of a medical condition or body part, or to accommodate the shorter or longer periods required for a sufficient level of training (e.g., marathon or ultra-marathon, or other wellness objectives for which a term shorter or longer than 12 weeks are required). The wellness plans can also be designed to interact with the user in ways best suited to the particular stage of behavior change, as will be described below.

Upon completion of a wellness program the user can be offered the ability to purchase a subscription to a continuation of the selected wellness plan, a more advanced wellness plan, or a wellness plan with a different wellness objective but that advances the user's wellness to a new level. Even after completion of the wellness program, the App can be used and can have reduced functionality.

### Wellness Plan Elements

In some exemplary embodiments, the wellness plan can provide the user with training, coaching, and education needed to empower the user to achieve the wellness objective. Such training, coaching, and education includes, but is not limited to, a guided training regimen (including but not limited to exercises to be performed, frequency, intensity, and duration), video files (including but not limited to demonstrations of exercises, cooking videos or motivational videos), audio files (e.g., podcasts or recorded messages), animations, articles, web pages, blog entries, recipes and nutritional advice and tips, motivational messages (which can be delivered via e-mail or text message), motivational messages pushed to users at daily, weekly and monthly intervals, demonstrations of exercises or cooking, community forums, social media platforms (e.g. Facebook®, Twitter® or personal webpages), webinars, telephonic wellness coaching (“TWC”), expert advice or gamification.

### Wellness Plan Subscriptions

In some exemplary embodiments, the wellness plans can be provided to users via a subscription. Users can select from among the wellness plan objectives and purchase a subscription to activate the chosen wellness plan. Once activated, all the features of the wellness plan can be enabled. The subscription can terminate after the fixed duration of the wellness plan has elapsed. Subscriptions for an individual wellness plan may be obtained by a number of methods, including, but not limited to, an Internet-Enabled acquisition or based on a wellness plan subscription code.

In an Internet-Enabled acquisition, the subscription for a wellness plan may be acquired by a number of internet-enabled methods, including purchase from a web page, purchase from an App store, or other means. These purchases or downloads may be made using a computer, tablet, smartphone, smart watch, smart eyewear, or other devices capable of receiving and sending instructions via the Internet. After purchasing a wellness plan subscription, the user can be directed to a web page or App store to download the wellness plan App.

Wellness plan subscriptions may also be made via purchase of a subscription code or subscription identifier. The subscription code can be unique to the particular wellness plan that can be identified via a database in a cloud server using database query computer algorithms.

In some exemplary embodiments, the subscription code can be a sequence of numbers, letters, or characters, or a combination of numbers, letters, and characters. Subscription codes and identifiers can also be in the form of machine-readable, camera-readable, optically-readable, or electronically readable images or signals such as, but not limited to, barcodes, matrix codes, quick response (QR) codes, RFID tags, touch tags, or magnetic strips, or similar coding methods. Subscription codes and identifiers can be printed, imprinted, embedded, encoded, laminated, and contained in or on different types of material, electronic, optical, or magnetic media. The codes and identifiers may be viewable on the media or may be revealed after removing a removable cover. Removable covers can include laminates or adhesive strips or any similar means. Removable covers can be removed by scratching, lifting, peeling, pulling, dissolving, or tearing of the removable cover.

In some exemplary embodiments, the subscription codes/identifiers can be provided on subscription cards. These cards can be composed of paper or plastic or other solid media. The subscription cards can display the title and a brief description of the wellness plan. Subscription cards may be colored to identify the wellness plan belonging to a particular grouping or function. Such groups or function can include, but are not limited to, weight loss and management, clinical health management, chronic disease management, rehabilitation, activity-based plans and life event(s). Subscription cards can be displayed at the point of purchase in the same manner as gift cards or financial transaction cards, including but not limited to, wall displays, display carousels or display racks.

Besides activating a wellness plan, the subscription codes/identifiers can also be used to provide marketing information such as a geographic location of purchase, vendor from which the purchase was made, including the vendor name and address, commercial type (e.g., wholesale or retail), store type (e.g., kiosk, shop or display rack), vendor class (e.g., sporting goods, apparel, electronic goods, household goods or department store), date of purchase and other user or vendor information.

The subscription codes/identifiers can be purchased at wholesale or retail stores, outlets, or kiosks. The subscription codes/identifiers can also be purchased through vending machines. The subscription codes/identifiers may also be available through other types of vendors. Subscription codes/identifiers can also be purchased, offered, or otherwise acquired at medical, rehabilitation, or treatment facilities and offices, or by trainers, midwives or insurers. Subscription codes/identifiers may be provided by third parties under licensing agreements and distributed to users.

Subscription codes/identifiers may also be offered as incentives, rewards, or coupons by third parties. Subscription codes/identifiers may also be bundled with other merchandise, including but not limited to, wellness monitoring devices, medical devices, activity tracking devices, wearable devices, electronic devices, sports apparel, sporting goods, sports peripherals such as mats or steps, machines, instruments or apparatuses for fitness or wellness related activities.

The subscription codes/identifiers can also be provided alongside a web address or App store address where users must go to download the wellness plan App that implements the wellness plan program. Users can input the subscription codes/identifiers into the wellness plan App to activate the wellness plan subscription.

### Wellness Plan Equipment

Each plan can require a corresponding activity and lifestyle tracking device. The user can be notified what activity and lifestyle tracker metrics are needed to implement the program at the time of the purchase. The user can also be notified what type or brand of activity and lifestyle tracker is compatible with the particular wellness plan. The user can also be notified as to the minimum requirements of a computing or mobile phone device or operating system.

Exemplary embodiments of the methods and systems according to the present disclosure will now be described with reference to the figures.

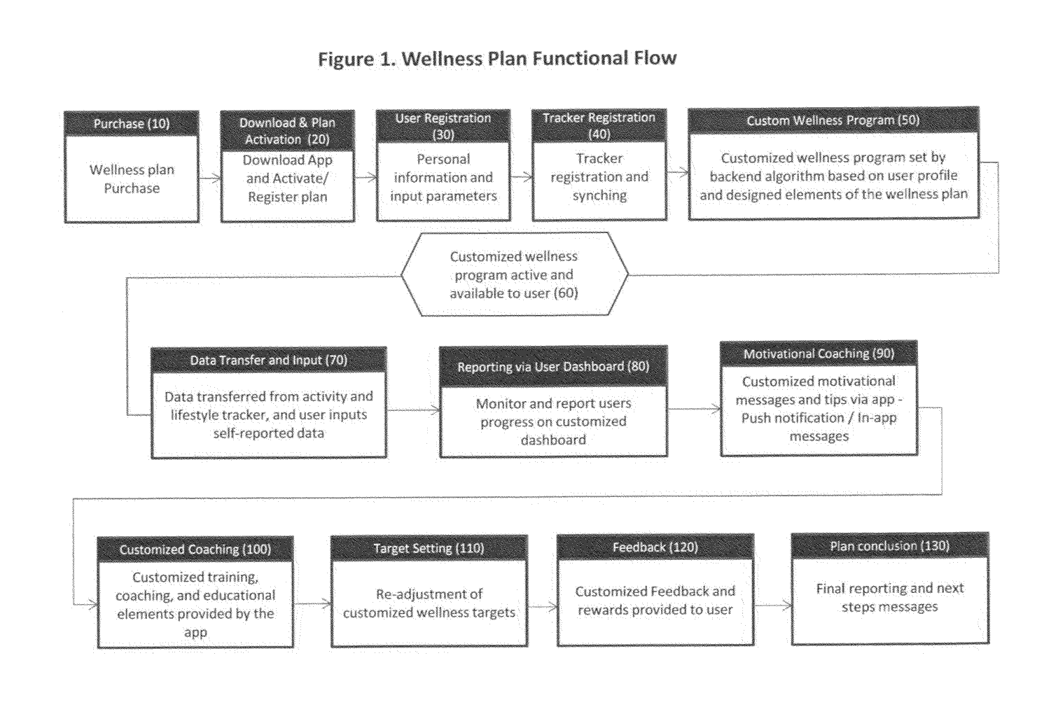

FIG. 1 is an illustration of a wellness plan according to an exemplary embodiment of the present disclosure, providing a wellness plan functional flow.

Initially, at 10, a purchase of the wellness plan can be made, and a wellness plan subscription can be selected and purchased by the user by any of the purchasing methods detailed above.

At 20, an App download and activation/registration can be provided, where the user can be directed to a web page or app store page from which they download the wellness plan application. The wellness plan application can be downloaded using any of the internet-enabled devices mentioned above. The wellness App resides on the user's device or devices and communicates with a database located on a cloud server. Information used by the wellness App can be maintained among the user's different devices by synching the devices using established synching protocols.

Upon opening or initiating the wellness plan App, the user can be queried to input the subscription code/identifier by either manually entering the code/identifier or capturing or scanning the machine-readable, camera-readable, optically-readable, or electronically-readable image or signals. The subscription code/identifier is compared against a database to identify the particular wellness plan purchased. The subscription code/identifier need only be entered once, at the initiation and activation of the wellness plan.

Alternatively, the user can purchase an individual wellness plan on-line or from within the App. In such a situation, a subscription code need not be provided to the user as the subscription is enabled from within the App. Alternatively, upon opening the App the user can be offered a free trial subscription that can allow use of the wellness plan for a specified number of weeks. Once the duration of the free trial subscription has elapsed, the user can be directed to purchase a subscription code to continue using the wellness plan. The user can be offered the option of starting their wellness plan at a later date. If a later date is chosen, a calendar entry for the start date can be sent to the user's electronic calendar.

At 30, user registration and input parameters can be provided. Following activation of the wellness plan subscription, the user can be asked to enter their personal information (e.g., name, location, e-mail address, mobile device phone number and social media account information). The user can then be prompted to enter user input parameters selected from the parameters described above.

Each wellness plan can query the user for a defined set of user input parameters. The set of user input parameters are determined by the wellness plan designer and are composed of the user input parameters which are used to enable the wellness plan including, but not limited to, those needed to assess and monitor the user, provide feedback, status and motivation, and determine the user's progress. For example, the post-natal wellness plan user input parameters can include activity during pregnancy, delivery date, and other pregnancy and childbirth related questions.

The user is also queried as to their preferred communication methods including, but not limited to, text messages, e-mails, social media, frequency of messages, etc. The user can also be queried if they want their progress to be posted or sent to social media. The user can also be queried if they want their progress to be sent to a third party, including but not limited to, a health professional, midwife, trainer or insurance provider. A user profile can be created which includes the user's personal information, user input parameters, and communication preferences. The user profile can be stored in a database located on a cloud server.

At 40, activity and lifestyle tracker information can be provided. The user can be prompted to enter information on the activity and lifestyle tracker they will be using. Each wellness plan can require a defined set of activity and lifestyle metrics that are needed to assess and monitor the user, provide feedback, status and motivation and determine the user's progress. The user may be asked to choose an activity and lifestyle tracker from among a list on a pull-down menu. The user's activity and lifestyle tracker can be added to the user's profile stored on a database. The user can then be asked to synch the tracker with the computing or communication device on which the App resides. The synching may be done via wired or wireless transmission depending upon the tracker and/or the computing or communication device. Wireless communication protocols include Bluetooth®.

At 50, a customized wellness program can be provided to the user. The customized wellness program can be developed by a specific computer algorithm. The user's profile stored in the database serves as the input to the algorithm. The algorithm can then account for the designed structure of the individual wellness plan, the wellness objectives of the wellness plan, and the training, coaching and education methods used by the wellness plan.

The output of the algorithm is a personalized wellness program customized to the user's unique set of input parameters and the wellness objectives of the wellness plan. The output of the algorithm includes, but is not limited to, one or more of types of exercises, frequency of exercises, duration of exercises, number of repetitions and sets of exercises, intensity of exercises, activity and lifestyle metrics to be monitored and reported, nutritional goals (e.g., calories to be consumed, portions of fat, protein, and carbohydrates), mode of communication, reporting to social media, frequency of communications, communication with health professional, goals, benchmarks, calories to be burned and exercise limitations. The output of the algorithm can be stored in a database on a cloud server.

At 60, the customized wellness program becomes active and available to the user. The user can be provided with an overview of the elements that will compose their wellness program including, but not limited to, the training, coaching, and education elements described above.

At 70, user data can be transferred and input. User data can be collected as the user proceeds along the wellness program. Data from the activity and lifestyle tracker is input to the user's wellness program by synching of the device by wired or wireless communication protocols. The user also inputs self-reported data not tracked by activity and lifestyle trackers, including but not limited to, food consumed, mood, confidence level, intensity, cigarettes smoked, body measurements, weight, blood pressure and non-recorded activities. The user's data is collected daily or at a frequency determined by the wellness plan and wellness program.

At 80, reporting can be provided via a customized user dashboard. The user can be provided with a web page or App screen on which is displayed a customized user dashboard. The dashboard includes information on the user's activity and nutrition and other parameters such as those described above. The dashboard can be customized for each wellness plan and can include information for achieving the wellness objective and/or training, coaching, or educating the user towards the wellness objective. The dashboard provides the user with daily, weekly, and monthly reports on their activity, nutrition and goals.

At 90, customized motivational coaching can be provided to the user. The wellness plan can send the user motivational messages and tips as the user proceeds through their customized wellness program. The motivational messages and tips may be sent via e-mail or text message, and can include, but are not limited to, text, video files, audio files, animations and graphical presentations. The motivational messages may be sent via push technology. Alternatively, the user may be sent e-mails or text messages that such motivational messages await them on their wellness dashboard. The motivational messages and tips can be stored in a database located on a cloud server. The algorithm can determine when and which messages should be sent.

At 100, customized training, coaching and educational elements can be provided. The training, coaching and educational elements identified above can be stored on a database on a cloud server. An algorithm is run to determine which elements are suited to the user. The algorithm inputs can be the given wellness plan, user profile, the user's customized wellness program, the stage the user is at in their customized wellness program, and the user's customized wellness targets (described below). The algorithm outputs can be a customized set of training, coaching, and educational elements made available to the user. The identified elements are made available to the user via e-mail, text message, or the user's dashboard. The user is informed of the availabilities of these elements on their dashboard by e-mail, text message, or as a message or pop-up screen when logging into their dashboard.

As noted above, psychology, sports psychology, and cognitive behavioral therapy have identified 12 weeks as the length of time needed to change existing behavior patterns and habits, and imprint, implement, and assimilate a new behavior. These 12 weeks can further be grouped into distinct stages: induction, reaction, and reformation. The 12-week wellness plans are designed to interact with the user in ways best suited to the particular stage of behavior change. During induction (e.g., weeks 1-4), coaching can focus on education including, but not limited to, demonstration of exercises, basic nutritional education, parameters and changes, and providing education about what needs to change. During reaction (e.g., weeks 5-8), coaching can focus on sustaining positive behaviors and changed behaviors. During reformation (e.g., weeks 9-12), coaching can focus on maintaining the new wellness objective and lifestyle. The frequency at which elements are made available to the user can be determined by the individual wellness plan, user profile, and benchmarks achieved by the user. In sum, the user is provided customized training, coaching, and education.

At 110, target setting can be provided. An algorithm can be implemented to monitor the user's progress toward the wellness objective of the wellness plan. Each wellness plan can implement a unique algorithm. Inputs to the algorithm can include the metrics provided by the activity and lifestyle trackers and the user's self-reported metrics, the customized wellness program, the rate of change of user's performance, information from the user's profile, and the wellness objective. The algorithm then outputs a series of activity and nutritional goals, targets, benchmarks, and/or metrics for the user to achieve (referred to as wellness targets). The frequency at which the algorithm is run and the wellness targets updated can be determined by the wellness plan. The algorithm can provide daily and/or weekly wellness targets. As such, the user can be provided customized wellness targets. The updated customized wellness targets can also serve as an input to determine which training, coaching, and educational elements are made available to the user. The updated customized wellness targets are shown on the user's dashboard in text, table, chart or graphical presentation.

At 120, feedback and rewards can be provided to the user. An algorithm can be implemented to provide the user feedback on their progress towards the wellness objective. Inputs to the feedback algorithm include the metrics provided by the activity and lifestyle trackers and the user's self-reported metrics, the wellness objectives of the wellness plan, the user's customized wellness program, the rate of change of the user's performance, the user's customized wellness targets and information from the user's profile. Outputs of the feedback algorithm can be notices to the user informing them if they are underperforming, performing at, or over performing the wellness target. If the user is exceeding the targets to a dangerous level they are notified to reduce their effort. As such, the user is provided with customized feedback.

The feedback may also include rewards if the user's customized wellness targets are achieved. Rewards include, but are not limited to, merchandise, reduced wellness plan subscriptions, and/or points towards gift card or club cards. The feedback and rewards may be sent via e-mail or text message and can include, but are not limited to, text, video files, audio files, animations, and graphical presentations. The feedback maybe sent via push technology. Alternatively, the user may be sent e-mails or text messages that feedback awaits them on their wellness dashboard.

At 130, a conclusion of the wellness plan can be provided. The wellness plan can conclude when the fixed term of its duration is reached. A final report can be made available to the user on the user dashboard. The option to download the activity and lifestyle tracker metrics and user self-reported metrics is made available to the user. These are formatted to those of a chosen file type and downloaded from the database on the cloud server on to the user's computing or communication device. The user can then be given the option to purchase a subscription to another wellness plan. Several options of wellness plans can be presented to the user to select from. These wellness plans are determined by the wellness plan the user has concluded and the progress toward the wellness objective they have achieved. Alternatively, the user is directed to select a wellness plan from among a library providing all the possible wellness plans.

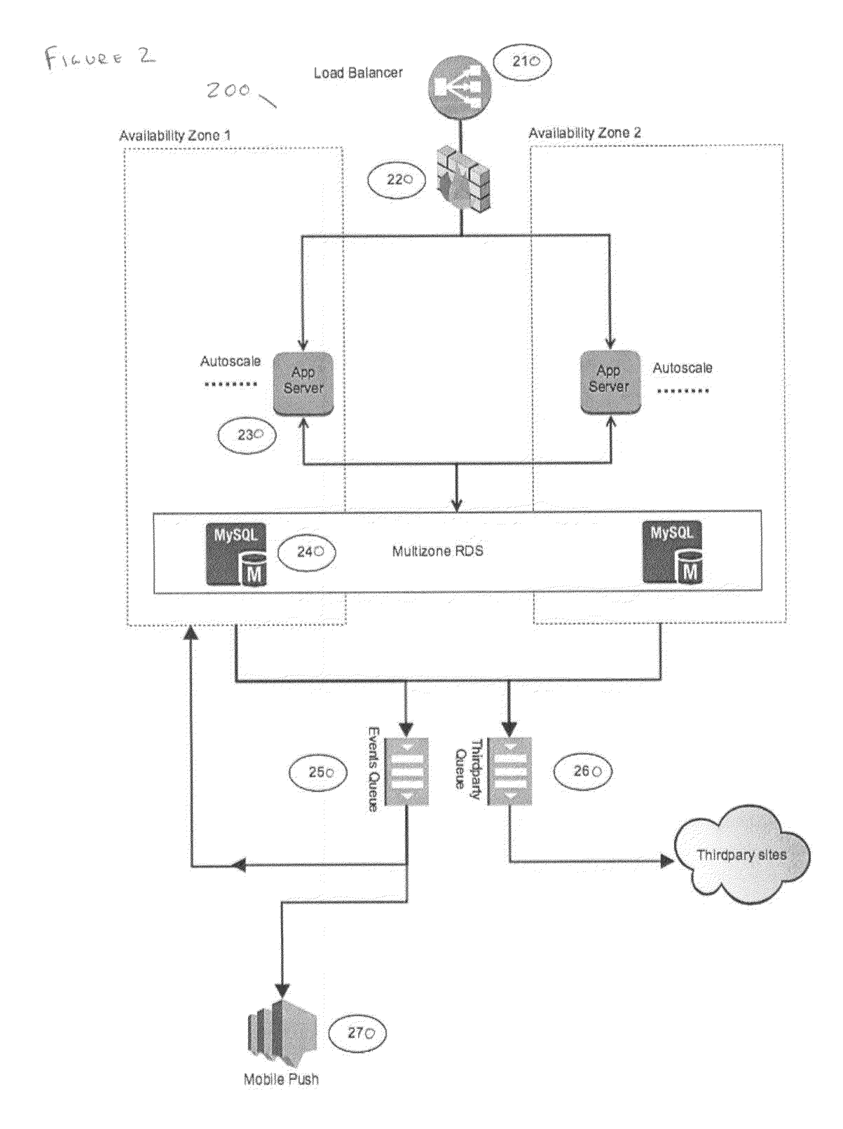

FIG. 2 is a block diagram of a wellness plan system 200 according to an exemplary embodiment of the present disclosure. As shown in FIG. 2, a load balancer 210 can be provided, where all web service calls made to the wellness plan system get processed by the load balancer 210 that diverts the traffic based on the wellness plan servers load. A firewall 220 can be provided, in which all requests coming from the load balancer 210 get matched against a white list. Only authorized ports and/or IP are allowed to pass through the firewall 220.

One or more App servers 230 can be provided that are hosted on multiple availability zones for high availability. The App servers 230 can also be designed to auto scale as demand grows on the system. Auto scaling will add on more App servers when load increases on the system. A database 240 can be provided where the wellness plan system 200 stores its data in the high availability database 240. The database 240 can be a SQL database or a non SQL database. In the exemplary embodiment of FIG. 2, the database 240 can be a MySQL SQL database.

An events queue 250 can be provided where the wellness plan system 200 can be an event-based system that processes events to achieve a scalable solution. Events can be notification, email, text message, targets, communication or any other component that the system needs to deliver it personalized plans. The events can be dispatched and processed from an events queue 250 that allows the scalability and parallel processing of events.

A third party queue 260 can be used to send and receive data from third parties. Such data can be activity, nutrition, body measurements, sleep or lifestyle data, but can also be content like articles and recipes. This data can be received from the third party and can also be pushed to the third party if needed. Mobile push 270 can be provided. As a coaching system, the wellness plan needs to remind, encourage and provide feedback to its users. This can be done via mobile push directly to user's phones.

Various other considerations can also be addressed in the exemplary applications described according to the exemplary embodiments of the present disclosure. Various criteria and parameters can be used for the wellness plans and various activity tracking devices can be used with the various wellness plans provided, and the exemplary embodiments of the present disclosure are not limited to any particular parameter or activity tracking device. The exemplary embodiments of the present disclosure can allow for customized wellness plans for users using activity tracking devices.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage media for execution by, or to control the operation of, data processing apparatus. Alternatively or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. The computer storage medium can be, or be included in, a computer-readable storage device, a computer-readable storage substrate, a random or serial access memory array or device, or a combination of one or more of them.

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or combinations of them. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, e.g., a virtual machine, or a combination of one or more of them. The apparatus and execution environment can realize various different computing model infrastructures, e.g., web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on mobile phones, smart phones, tablets, personal digital assistants, and computers having display devices, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, tactile feedback, etc.; and input from the user can be received in any form, including acoustic, speech, tactile input, etc. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network, e.g., the Internet, and peer-to-peer networks, e.g., ad hoc peer-to-peer networks.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page to a client device, e.g., for purposes of displaying data to and receiving user input from a user interacting with the client device. Data generated at the client device, e.g., a result of the user interaction can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. In some cases, the actions recited in the claims can be performed in a different order and still achieve desirable results. Moreover, the separation of various system components in the embodiments described above should not be understood as requiring such separation in all embodiments, and it should be understood that the described program components and systems can generally be integrated together in a single software product or packaged into multiple software products.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method of providing a wellness plan, comprising:
offering one or more wellness plans to a user;
allowing the user to enter input parameters personal to the user;
synching an activity tracking device with information associated with the user for use with a chosen wellness plan;
configuring a customized wellness plan for the user based on an algorithm and the input parameters; and
providing the customized wellness plan to the user.

2. The method of claim 1, wherein the customized wellness plan includes one or more of types of exercises, frequency of exercises, duration of exercises, number of repetitions and sets of exercises, intensity of exercises, activity and lifestyle metrics to be monitored and reported, nutritional goals, mode of communication, reporting to social media, frequency of communications, communication with health professional, goals, benchmarks, calories to be burned and exercise limitations.

3. The method of claim 1, further comprising:
determining compliance with the customized wellness plan using synchronization of data from the activity tracking device.

4. The method of claim 1, wherein the customized wellness plan is for a fixed duration of time.

5. The method of claim 4, further comprising:
using a customized algorithm to determine the user's progress based on the customized wellness plan during the fixed duration of time.

6. The method of claim 5, wherein the fixed duration of time is from one to twelve weeks.

7. The method of claim 1, further comprising:
offering customized motivational coaching with the customized wellness plan to the user to ensure compliance with the customized wellness plan.

8. The method of claim 7, wherein the customized motivation coaching includes motivational messages and tips for completing the customized wellness program.

9. The method of claim 1, further comprising:
providing customized training to the user based on a specific algorithm suited to the particular user.

10. The method of claim 9, wherein the algorithm is based on the customized wellness plan and the input parameters.

11. The method of claim 10, wherein the customized training includes one or more of audio files, video files and text files.

12. The method of claim 1, further comprising:
offering a reward or feedback to the user upon successful completion of the customized wellness plan.

13. The method of claim 1, further comprising:
offering another wellness plan after completion of the customized wellness plan based on activity by the user in the customized wellness plan.

14. The method of claim 1, wherein the one or more wellness plans offered are based on one or more wellness objectives.

15. The method of claim 14, wherein the wellness objectives include one or more of fitness goals, conditioning of a targeted body member or region of the body, health situation, rehabilitation need, activity, lifestyle, life event and a life goal.

16. The method of claim 1, wherein the one or more wellness plans offered are based on a subscription.

17. The method of claim 16, wherein the subscription is Internet enabled or based on a subscription code.

18. The method of claim 1, wherein the subscription ends after a fixed duration of time.

19. The method of claim 1, wherein the activity tracking device is one of a pedometer, accelerometer, altimeter, tachometer, oxygen partial pressure (pO2) sensor, calorimeter, gyroscope, actuator, pressure sensor, speed sensor, camera, heart rate monitor, heart rate measuring device, pulse measuring device, blood pressure measuring device, temperature measurement device, temperature sensor, location tracking device, GPS, computer, brain wave sensor, sleep sensor or scale.

20. The system of claim 1, further comprising:
providing information regarding the progress of the user based on the customized wellness plan in a customized software application for the user.
